(19) United States
(12) Patent Application Publication
(10) Pub. No.: US 2025/0140930 A1
(43) Pub. Date: May 1, 2025

(54) NONAQUEOUS ELECTROLYTIC SOLUTION SECONDARY BATTERY

(71) Applicant: Prime Planet Energy & Solutions, Inc., Tokyo (JP)

(72) Inventor: Kento HOSOE, Miyoshi-shi (JP)

(21) Appl. No.: 18/922,408

(22) Filed: Oct. 22, 2024

(30) Foreign Application Priority Data
Oct. 26, 2023 (JP) 2023-183731

(51) Int. Cl. H01M 10/0569; H01M 4/36; H01M 4/587; H01M 10/0525; H01M 10/0568; H01M 10/42

(52) U.S. Cl. CPC H01M 10/0569; H01M 4/366; H01M 4/587; H01M 10/0525; H01M 10/0568; H01M 10/4235; H01M 2300/004

(57) ABSTRACT

A secondary battery 100 disclosed herein includes a negative electrode 60 and a nonaqueous electrolytic solution 80. The negative electrode 60 includes a negative electrode active material layer 64 containing a negative electrode active material. The negative electrode active material includes a carbon material and an amorphous carbon coat layer covering the carbon material. The negative electrode active material has a strength ratio (D/G) of a peak strength G at 1580 cm⁻¹ and a peak strength D at 1360 cm⁻¹ under a Raman spectrum analysis is equal to or more than 0.3 and not more than 0.5. The nonaqueous electrolytic solution 80 contains at least a sulfur type electrolyte salt and a nonaqueous solvent, and a nonaqueous solvent contains a carbonate type solvent and methyl acetate. A SOx concentration of the negative electrode active material layer 64 is equal to or more than 0.3 atomic %.

### CROSS REFERENCE TO RELATED APPLICATIONS

The present application claims the priority based on Japanese Patent Application No. 2023-183731 filed on Oct. 26, 2023, and the entire contents of the prior application are incorporated in the present specification by reference.

### BACKGROUND

### 1. Technical Field

A technique disclosed herein relates to a nonaqueous electrolytic solution secondary battery.

### 2. Description of the Related Art

Recently, a nonaqueous electrolytic solution secondary battery, such as lithium ion secondary battery, is suitably used for a portable power supply of a personal computer, a mobile terminal, or the like, or used for a power supply for driving automobiles, such as electric vehicle (BEV), hybrid vehicle (HEV), and plug-in hybrid vehicle (PHEV).

The nonaqueous electrolytic solution secondary battery is, in general, configured with an electrode body including a positive electrode and a negative electrode and with a nonaqueous electrolytic solution, which are accommodated in a battery case. As a technique related to this, it is possible to refer to, for example, JP2022-129682, JP2017-103240, and JP2019-160730. JP2022-129682 discloses a nonaqueous electrolytic solution that contains an oxalate salt, a chemical compound including 2 or more ring-shaped carboxylic acid anhydride skeletons in a molecule, and a chain carboxylic acid ester whose carbon number is equal to or less than 5, for a purpose of improving a rate characteristic, a storage capacity maintenance rate, and a high temperature storage gas generation amount. JP2017-103240 discloses a nonaqueous electrolytic solution that contains an ester type solvent and a carbonate type solvent but that does not contain a sulfur chemical compound. In addition, JP2019-160730 discloses a secondary battery that includes a negative electrode containing at least a carbon fiber aggregate and a lithium metal.

### SUMMARY

Regarding the nonaqueous electrolytic solution secondary battery, after storage, it is difficult to achieve both decreasing a resistance increasing rate (a low resistance) and securing a capacity maintenance rate being higher (a high capacity maintenance rate). On the other hand, recently, it is expected on the nonaqueous electrolytic solution secondary battery to enhance a storage characteristic (for example, to suppress a resistance increasing rate or to suppress reduction of the capacity maintenance rate, after the storage).

The present disclosure has been made in view of the above-described circumstances, and the main object is to provide the nonaqueous electrolytic solution secondary battery whose storage characteristic has been enhanced.

A nonaqueous electrolytic solution of the herein disclosed battery member includes a positive electrode, a negative electrode, and a nonaqueous electrolytic solution. The negative electrode includes a negative electrode active material layer containing a negative electrode active material, and the negative electrode active material includes a carbon material and an amorphous carbon coat layer covering the carbon material. In the negative electrode active material, a strength ratio (D/G) of a peak strength G at 1580 cm⁻¹ and a peak strength D at 1360 cm⁻¹ under a Raman spectrum analysis measured by a Raman spectroscopy is equal to or more than 0.3 and not more than 0.5. The nonaqueous electrolytic solution contains at least a sulfur type electrolyte salt and a nonaqueous solvent, and the nonaqueous solvent contains a carbonate type solvent and methyl acetate. Here, in the negative electrode active material layer, a SOx concentration calculated on a basis of a XPS spectrum measured by a X-ray photoelectron spectroscopy is equal to or more than 0.3 atomic %.

Regarding the nonaqueous electrolytic solution secondary battery including the configuration described above, a sulfur(S) element is taken as a SOx form in a coating film formed on the negative electrode after an activation treatment, and thus it is possible to form a suitable coating film on the negative electrode. The coating film described above has a low resistance, and then a Li loss being an irreversible reaction is decreased. By doing this, it is possible to implement the nonaqueous electrolytic solution secondary battery that has an outstanding storage characteristic (particularly, suppression on the resistance increase and suppression on the capacity maintenance rate reduction).

### BRIEF DESCRIPTION OF THE DRAWINGS

FIG. 1 is a cross section view that schematically shows an inside structure of a lithium ion secondary battery in accordance with one embodiment.

FIG. 2 is a schematic exploded view that shows a configuration of a wound electrode body of the lithium ion secondary battery in accordance with one embodiment.

### DETAILED DESCRIPTION

Below, while referring to figures, an embodiment in accordance with the present disclosure would be explained. Incidentally, a matter not described in the present specification but required for performing the present disclosure can be grasped as design matters of those skilled in the art based on the related art in the present field. The present disclosure can be executed based on the contents disclosed in the present specification, and the technical common sense in the present field. Additionally, in the following accompanying drawings, the same numerals and signs are given to the members/parts providing the same effect. Further, the dimensional relation (such as length, width, and thickness) in each drawing does not always reflect the actual dimensional relation. Incidentally, a numerical value range expressed as “A to B” in the present specification includes A and B.

Incidentally, a term “secondary battery” in the present specification indicates an electric storage device that is capable of repeatedly charging and discharging. In addition, a term “nonaqueous electrolytic solution secondary battery” in the present specification represents a general battery that is capable of repeatedly charging and discharging by having an electric charge carrier moving between a positive electrode and a negative electrode via the nonaqueous electrolytic solution. In addition, a term “lithium ion secondary battery” represents a secondary battery that uses a lithium ion as an electric charge carrier and that implements charging and discharging by movement of an electric charge due to the lithium ion between the positive electrode and the negative electrode.

Below, the present disclosure would be described in detail with a lithium ion secondary battery, as an example, formed in a flat square shape that includes a wound electrode body formed in a flat shape and includes a battery case formed in a flat shape, but it is not intended to restrict the present disclosure to one described in an embodiment.

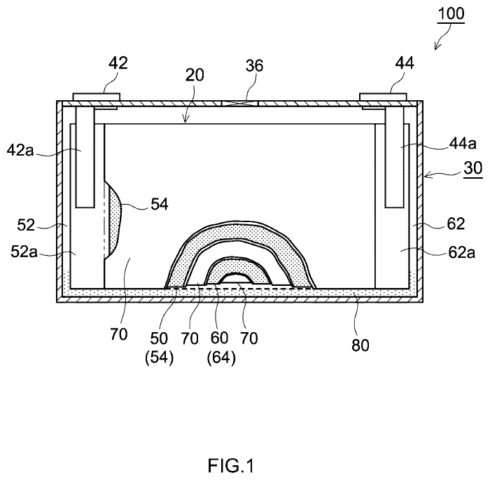

FIG. 1 is a cross section view that schematically shows an inside structure of a nonaqueous electrolytic solution secondary battery 100 disclosed herein. The nonaqueous electrolytic solution secondary battery 100 shown in FIG. 1 is a sealed type battery constructed by making a wound electrode body 20 formed in a flat shape and a nonaqueous electrolytic solution 80 be accommodated in a battery case 30 having a flat square shape (in short, an exterior container). The battery case 30 is provided with a positive electrode terminal 42 and a negative electrode terminal 44 which are for outside connection, and with a thin-walled safe valve 36 which is set to release an internal pressure of the battery case 30 when the internal pressure rises to be equal to or more than a predetermined level. In addition, the battery case 30 is provided with an injection port (not shown) which is for injecting the nonaqueous electrolytic solution 80. The positive electrode terminal 42 is electrically connected to a positive electrode current collector plate 42a. The negative electrode terminal 44 is electrically connected to a negative electrode current collector plate 44a. As a material of the battery case 30, for example, it is possible to use a metal material being lightweight and having a good thermal conductivity, such as aluminum. Incidentally, FIG. 1 is not intended to accurately show an amount of the nonaqueous electrolytic solution 80.

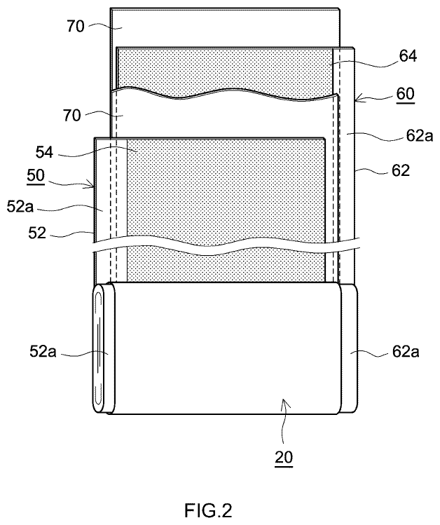

FIG. 2 is a schematic exploded view that shows a configuration of the wound electrode body 20 of the herein disclosed nonaqueous electrolytic solution secondary battery 100. The wound electrode body 20 has a form, as shown in FIG. 1 and FIG. 2, in which a positive electrode sheet 50 and a negative electrode sheet 60 are stacked one on another through 2 long separator sheets 70 so as to be wound therein in a longitudinal direction. The positive electrode sheet 50 has a configuration in which a positive electrode active material layer 54 is formed along a longitudinal direction on one surface or both surfaces (here, both surfaces) of a positive electrode current collector 52 formed in a long shape. The negative electrode sheet 60 has a configuration in which a negative electrode active material layer 64 is formed along the longitudinal direction on one surface or both surfaces (here, both surfaces) of a negative electrode current collector 62 formed in a long shape. A positive electrode active material layer non-formation portion 52a (in other words, a portion on which the positive electrode active material layer 54 is not formed and the positive electrode current collector 52 is exposed) and a negative electrode active material layer non-formation portion 62a (in other words, a portion on which the negative electrode active material layer 64 is not formed and the negative electrode current collector 62 is exposed) are formed to protrude outwardly from both ends in a winding axis direction of the wound electrode body 20 (in other words, a sheet width direction that is orthogonal to the longitudinal direction). To the positive electrode active material layer non-formation portion 52a and the negative electrode active material layer non-formation portion 62a, the positive electrode current collector plate 42a and the negative electrode current collector plate 44a are respectively joined.

The positive electrode 50 (the positive electrode sheet 50) includes the positive electrode current collector 52, and the positive electrode active material layer 54 arranged on at least one surface of the positive electrode current collector 52. As the positive electrode current collector 52, it is possible to use a well known positive electrode current collector that is used for the lithium ion secondary battery, and it is possible as an example to use a sheet or a foil made from a metal having a favorable electrical conductivity (for example, aluminum, nickel, titanium, stainless steel, or the like). As the positive electrode current collector 52, it is preferable to use an aluminum foil. A size of the positive electrode current collector 52 is not particularly restricted, and should be suitably decided in accordance with the battery plan. In a case where the aluminum foil is used as the positive electrode current collector 52, a thickness of it is not particularly restricted but, for example, is equal to or more than 5 μm and not more than 35 μm, or preferably equal to or more than 7 μm and not more than 20 μm.

The positive electrode active material layer 54 contains a positive electrode active material. As the positive electrode active material, it is possible to use a well known positive electrode active material that is used for the lithium ion secondary battery. Particularly, for example, as the positive electrode active material, it is possible to use a lithium composite oxide, a lithium transition metal phosphate compound, or the like. A crystal structure of the positive electrode active material, which is not particularly restricted, might be a layer-shape structure, a spinel structure, an olivine structure, or the like.

Regarding the lithium composite oxide, as the transition metal element, it is preferable to use a lithium-transition metal complex oxide that contains at least 1 kind among Ni, Co, and Mn, and as a specific example, it is possible to use a lithium nickel type composite oxide, a lithium cobalt type composite oxide, a lithium manganese type composite oxide, a lithium nickel manganese type composite oxide, a lithium-nickel-cobalt-manganese type composite oxide, a lithium nickel cobalt aluminum type composite oxide, a lithium iron nickel manganese type composite oxide, or the like. Regarding these positive electrode active materials, it is possible to use 1 kind singly, or to use combination of 2 or more kinds.

Incidentally, the wording “lithium-nickel-cobalt-manganese type composite oxide” in the present specification is a term that semantically covers not only an oxide whose configuration element is Li, Ni, Co, Mn, or O, but also an oxide which contains 1 kind, 2 kinds, or more of additive elements other than them. As an example of the additive elements described above, it is possible to use a transition metal element, a typical metal element, or the like, such as Mg, Ca, Al, Ti, V, Cr, Y, Zr, Nb, Mo, Hf, Ta, W, Na, Fe, Zn, and Sn. In addition, the additive element might be a semimetal element, such as B, C, Si, and P, or a non-metal element, such as S, F, Cl, Br, and I. This matter is similarly true in the above described lithium nickel type composite oxide, lithium cobalt type composite oxide, lithium manganese type composite oxide, lithium nickel manganese type composite oxide, lithium nickel cobalt aluminum type composite oxide, lithium iron nickel manganese type composite oxide, or the like.

As the lithium transition metal phosphate compound, for example, it is possible to use lithium iron phosphate (LiFePO₄), lithium manganese phosphate (LiMnPO₄), lithium manganese iron phosphate, or the like.

As the positive electrode active material, it is possible in particular to preferably use the lithium-nickel-cobalt-manganese type composite oxide.

An average particle diameter of the positive electrode active material (a particle diameter at accumulation 50% on a volume basis particle size distribution obtained by a particle size distribution measurement based on a laser-diffraction/light-scattering method), which is not particularly restricted, is, for example, equal to or more than 0.05 μm and not more than 25 μm, preferably equal to or more than 1 μm and not more than 20 μm, or further preferably equal to or more than 3 μm and not more than 15 μm.

The positive electrode active material layer 54 might contain a component other than the positive electrode active material, for example, an electrically conducting material, a binder, or the like. As the electrically conducting material, for example, it is possible to suitably use a carbon material, such as carbon black (example, acetylene black (AB)), carbon nanotube, and graphite. As the binder, for example, it is possible to use polyvinylidene fluoride (PVdF), or the like.

A content amount of the positive electrode active material in the positive electrode active material layer 54 (in other words, a content amount of the positive electrode active material with respect to a total mass of the positive electrode active material layer 54), which is not particularly restricted, is preferably equal to or more than 70 mass %, further preferably equal to or more than 80 mass % and not more than 97 mass %, or furthermore preferably equal to or more than 85 mass % and not more than 96 mass %. The content amount of the electrically conducting material in the positive electrode active material layer 54, which is not particularly restricted, is preferably equal to or more than 1 mass % and not more than 15 mass %, or further preferably equal to or more than 3 mass % and not more than 13 mass %. The content amount of the binder in the positive electrode active material layer 54, which is not particularly restricted, is preferably equal to or more than 1 mass % and not more than 15 mass %, or further preferably equal to or more than 1.5 mass % and not more than 10 mass %.

A thickness of the positive electrode active material layer 54, which is not particularly restricted, for example, is equal to or more than 10 μm and not more than 400 μm, or preferably equal to or more than 20 μm and not more than 300 μm.

The positive electrode sheet 50 might include an insulation layer (not shown) at a boundary part between the positive electrode active material layer non-formation portion 52a and the positive electrode active material layer 54. This insulation layer contains, for example, a ceramic particle, or the like.

The negative electrode 60 includes the negative electrode current collector 62 and the negative electrode active material layer 64 fixed on at least one surface of the negative electrode current collector 62. As the negative electrode current collector 62, it is possible to use a well known negative electrode current collector that is used for the lithium ion secondary battery, and it is possible as an example to use a sheet or a foil made from a metal having a favorable electrical conductivity (for example, copper, nickel, titanium, stainless steel, or the like). As the negative electrode current collector 62, it is preferable to use a copper foil. A size of the negative electrode current collector 62 is not particularly restricted, and should be suitably decided in accordance with the battery plan. In a case where the copper foil is used as the negative electrode current collector 62, a thickness of it is not particularly restricted but, for example, equal to or more than 5 μm and not more than 35 μm, or preferably equal to or more than 6 μm and not more than 20 μm.

It was found regarding the negative electrode active material layer 64 of the herein disclosed nonaqueous electrolytic solution secondary battery 100 by a X-ray photoelectron spectroscopy (XPS) that a sulfur(S) element was taken as a SOx form in a coating film that was formed on the negative electrode. Then, it was found that, in a case where a SOx concentration of it is equal to or more than 0.3 atomic %, a resistance increasing rate of the nonaqueous electrolytic solution secondary battery 100 after the storage was suitably suppressed and, in addition, a capacity maintenance rate was high even after the storage. Although it is not intended to restrict the herein disclosed technique, a reason why the effect described above is obtained could be estimated as described below. Regarding the nonaqueous electrolytic solution secondary battery 100 after an activation treatment, a part of the nonaqueous electrolytic solution 80 is subjected to a reduction decomposition so as to form a coating film referred to as SEI membrane (Solid Electrolyte Interface) on the surface of the negative electrode. When the SEI membrane is suitably formed, the negative electrode is stabilized and thus it is possible to provide the nonaqueous electrolytic solution secondary battery 100 having a favorable storage characteristic. On the other hand, when the SEI membrane is excessively formed, it tends to reduce the storage characteristic of the secondary battery (for example, to increase the resistance rate or to reduce the capacity maintenance rate, after the storage). Based on results examined by the present inventors, by making the sulfur(S) element be taken as the SOx form in the coating film formed on the negative electrode and by making the SOx concentration be high (in particular, equal to or more than 0.3 atomic %), it is possible to suppress the excessive form (growth) of the SEI membrane and to form the suitable SEI membrane on the negative electrode. The SEI membrane described above has a low resistance and a Li loss being an irreversible reaction is decreased. By doing this, it is possible to implement the nonaqueous electrolytic solution secondary battery 100 superior to the storage characteristic.

Whether the SOx is present on the negative electrode can be confirmed, for example, by an X-ray photoelectron spectroscopy (XPS) analysis. In particular, a XPS spectrum measured by the XPS includes a peak Ps ascribed to the SOx at a position where a binding energy is 165 to 175 eV (for example, at a vicinity of 169 eV). The peak Ps described above means the presence of the SOx. In addition, the SOx state ratio (the SOx concentration) in the negative electrode active material layer can be measured by the XPS analysis. In particular, by correcting a peak area size of the obtained peak Ps with a sensitivity coefficient in consideration of occurrence of photoelectrons, it is possible to obtain a state ratio of the SOx. Incidentally, this SOx state ratio means the state ratio (the concentration) of the SOx on the outermost surface of the negative electrode active material layer 64 in a case where the peak area size obtained within a range from 0 to 1100 eV is represented by an atomic percentage (100 atomic %).

The SOx concentration (the SOx state ratio) measured by the above described method might be equal to or more than 0.3 atomic %, might be equal to or more than 0.4 atomic %, or might be equal to or more than 0.5 atomic %. An upper limit of the concentration of the SOx in the negative electrode active material layer, which is not particularly restricted, might be equal to or less than 2 atomic %, might be equal to or less than 1 atomic %, or might be equal to or less than 0.7 atomic %.

The negative electrode active material layer 64 contains a negative electrode active material. In the herein disclosed nonaqueous electrolytic solution secondary battery 100, the negative electrode active material includes a carbon material and an amorphous carbon coat layer that covers the carbon material. Although a type of the carbon material is not particularly restricted, it is possible to use, for example, a natural graphite, an artificial graphite, or the like. The amorphous carbon coat layer can be configured with, for example, a hardly graphitized carbon, an easily graphitized carbon, an activated carbon, or the like. Among them, it is preferable that the negative electrode active material is an amorphous carbon coated graphite in which a surface of the graphite is coated by a carbon material having a low crystallinity.

The negative electrode active material includes, as described above, the carbon material and the amorphous carbon coat layer that covers the carbon material. In other words, the negative electrode active material might be a mixture or a composite, which is configured with carbon materials respectively having different crystallinities. Here, the crystallinity of the negative electrode active material can be evaluated by a Raman spectrum analysis. For measurement of the Raman spectrum, it is possible to suitably apply a conventionally known method. For example, by using a laser Raman spectroscopy with laser light (for example, argon ion laser) being suitable as a light source, it is possible to measure the Raman spectrum. Regarding the negative electrode active material of the herein disclosed nonaqueous electrolytic solution secondary battery 100, a strength ratio (D/G) with respect to a peak strength G at 1580 cm⁻¹ and a peak strength D at 1360 cm⁻¹ in the Raman spectrum analysis measured by a Raman spectroscopy is equal to or more than 0.3 and not more than 0.5. The D/G ratio described above is a ratio of a strength of the D peak reflecting an irregular structure with respect to a strength of the G peak reflecting a regular graphite structure, and would be also referred to as R value. By adjusting to make the strength ratio (D/G) be equal to or more than 0.3 and not more than 0.5, it is possible to say that the negative electrode active material has the appropriate crystallinity. By combining the negative electrode active material whose strength ratio (D/G) is adjusted to be equal to or more than 0.3 and not more than 0.5 and the nonaqueous electrolytic solution which is described later, it is possible to suitably enhance the SOx concentration in the negative electrode active material layer 64.

Incidentally, in the present specification, the wording “the peak strength at 1580 cm⁻¹” means a peak strength at a vicinity of 1580 cm⁻¹ (for example, a range (G band) from 1580 cm-1 to 1620 cm⁻¹). Additionally, in the present specification, the wording “the peak strength at 1360 cm⁻¹” means a peak strength at a vicinity of 1360 cm⁻¹ (for example, a range (D band) from 1300 cm⁻¹ to 1400 cm⁻¹).

In the negative electrode active material, the above described strength ratio (D/G) might be equal to or more than 0.3, might be equal to or more than 0.32, might be equal to or more than 0.34, or might be equal to or more than 0.35. Additionally, in the negative electrode active material, the above described strength ratio (D/G) might be equal to or less than 0.5, might be equal to or less than 0.48, might be equal to or less than 0.45, might be equal to or less than 0.42, might be equal to or less than 0.4, or might be equal to or less than 0.38. By doing this, it is possible to implement the negative electrode active material whose crystallinity is not too high and is not too low.

It is preferable that the negative electrode active material is formed in a particle shape. Although not particularly restricted, an average particle diameter of the negative electrode active material (a particle diameter of accumulation 50% on a volume basis particle size distribution obtained by a particle size distribution measurement based on a laser-diffraction/light-scattering method), is, for example, equal to or more than 0.5 μm and not more than 50 μm, preferably equal to or more than 1 μm and not more than 20 μm, or further preferably equal to or more than 5 μm and not more than 10 μm.

The negative electrode active material having the strength ratio (D/G) as described above can be manufactured by a conventionally known method. For example, at first, the graphite material as a raw material and the amorphous carbon material (for example, the easily graphitized carbon) are prepared. Next, by a gas phase method, such as CVD method (Chemical Vapor Deposition), or by a liquid phase method, a solid phase method, or the like, the amorphous carbon material is made to stick on the surface of the graphite material. Then, by baking the graphite material, on which the amorphous carbon material has stuck, for example, at generally 800 to 1500° C. and then by carbonizing the resultant, it is possible to manufacture the negative electrode active material (the amorphous carbon coated graphite). Incidentally, the D/G value of the negative electrode active material can be adjusted by, for example, the D/G value of the used raw material (the graphite material and/or the amorphous carbon material), a mix ratio of the raw materials, baking temperature at the baking time, or the like.

The negative electrode active material layer 64 can contain a component other than the active material, for example, a binder, a thickening agent, or the like. As the binder, it is possible to use, for example, styrene butadiene rubber (SBR), polyvinylidene fluoride (PVdF), or the like. As the thickening agent, it is possible to use, for example, carboxymethyl cellulose (CMC), or the like.

A content amount of the negative electrode active material in the negative electrode active material layer 64 is preferably equal to or more than 90 mass %, or further preferably equal to or more than 95 mass % and not more than 99 mass %. A content amount of the binder in the negative electrode active material layer 64 is preferably equal to or more than 0.1 mass % and not more than 8 mass %, or further preferably equal to or more than 0.5 mass % and not more than 3 mass %. A content amount of the thickening agent in the negative electrode active material layer 64 is preferably equal to or more than 0.3 mass % and not more than 3 mass %, or further preferably equal to or more than 0.5 mass % and not more than 2 mass %.

A thickness of the negative electrode active material layer 64, which is not particularly restricted, is, for example, equal to or more than 10 μm and not more than 400 μm, or preferably equal to or more than 20 μm and not more than 300 μm.

As the separator 70 (the separator sheet 70), for example, it is possible to use a porous sheet (a film) configured with a resin, such as polyethylene (PE), polypropylene (PP), polyester, cellulose, and polyamide. The porous sheet described above might be configured to have a single layer structure, or might be configured to have a laminate structure including two or more layers (for example, three layers structure in which PP layers are laminated on both surfaces of a PE layer). A surface of the separator 70 might be provided with a heat resistance layer (HRL) that contains a ceramic particle, or the like. A thickness of the separator 70, which is not particularly restricted, is, for example, equal to or more than 5 μm and not more than 50 μm, or preferably equal to or more than 10 μm and not more than 30 μm.

The nonaqueous electrolytic solution 80 contains a nonaqueous solvent and an electrolyte salt (which might be also referred to as a supporting salt). The nonaqueous electrolytic solution 80 contains at least a sulfur type electrolyte salt, a carbonate type solvent, and methyl acetate. By combining the nonaqueous electrolytic solution as described above and the above described negative electrode active material whose D/G ratio has been suitably adjusted, it is possible to make the SOx derived from the sulfur type electrolyte salt be suitably taken in the surface of the negative electrode active material layer 64, so as to enhance the SOx concentration. By doing this, it is implemented to suppress the resistance increase and to suppress the capacity maintenance rate reduction, of the nonaqueous electrolytic solution secondary battery 100 after the storage.

The sulfur type electrolyte salt is not particularly restricted, if being an electrolyte salt containing the sulfur atom. As the sulfur type electrolyte salt, it is possible to use, for example, lithium bis(fluorosulfonyl)imide (LiFSI), lithium bis(trifluoromethane) sulfonimide (LiTFSI), or the like. Among them, it is preferable that the sulfur type electrolyte salt contains the LiFSI. A concentration of the above described sulfur type electrolyte salt in the nonaqueous electrolytic solution, which is not particularly restricted, is preferably equal to or more than 0.5 mass % and not more than 3 mass %, or further preferably equal to or more than 0.5 mass % and not more than 1.5 mass %.

The nonaqueous electrolytic solution 80 might contain an electrolyte salt other than the sulfur type electrolyte salt. For the electrolyte salt as described above, it is possible to use, for example, LiPF₆, LiBF₄, or the like. A concentration of the electrolyte salt other than the sulfur type electrolyte salt in the nonaqueous electrolytic solution, which is not particularly restricted, is preferably equal to or more than 0.7 mol/L and not more than 1.3 mol/L.

The nonaqueous electrolytic solution secondary battery 100 disclosed herein contains the carbonate type solvent and the methyl acetate, as the nonaqueous solvent. As an example of the carbonate type solvent, it is possible to use ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluoro dimethyl carbonate (TFDMC), or the like. Regarding the carbonate type solvent as described above, it is possible to use 1 kind singly, or to use suitable combination of 2 or more kinds. Among them, as the carbonate type solvent, it is preferable to contain at least ethylene carbonate.

From a perspective of suitably rising the SOx concentration on the surface of the negative electrode active material layer, it is preferable, in a case where a volume of the whole nonaqueous solvent is treated as 100 vol %, to contain the methyl acetate whose amount is equal to or more than at least 10 vol %. The content amount of the methyl acetate is, for example, preferably equal to or more than 20 vol %, or further preferably equal to or more than 30 vol %. An upper limit of the content amount of the methyl acetate, which is not particularly restricted, is preferably, for example, equal to or less than 80 vol %, or further preferably equal to or less than 70 vol %. The content amount (vol %) of the methyl acetate described above can be obtained, for example, by a NMR analysis, or the like.

Although not particularly restricted, a content rate of the carbonate type solvent and the methyl acetate in the nonaqueous solvent is, for example, preferably 90:10 to 20:80, or further preferably 90:10 to 30:70. By doing this, the above described effect is stably exhibited, and thus it is possible to suitably enhance the storage characteristic of the nonaqueous electrolytic solution secondary battery 100.

The nonaqueous electrolytic solution 80 might contain a component, other than the nonaqueous solvent and the electrolyte salt (hereinafter, referred to as an arbitrary component, too). As a suitable example of this arbitrary component, it is possible to use various additive agents which might be a coating film forming agent, such as vinylene carbonate and oxalate complex; a thickening agent; a gas generating agent, such as biphenyl (BP) and cyclohexylbenzene (CHB); or the like.

Above, the nonaqueous electrolytic solution secondary battery 100 formed in a square shape that includes the wound electrode body 20 formed in a flat shape has been explained as an example. However, the lithium ion secondary battery might be configured as a nonaqueous electrolytic solution secondary battery including a laminate type electrode body (in other words, an electrode body in which plural positive electrodes and plural negative electrodes are alternately laminated). In addition, the lithium ion secondary battery can be configured as a cylindrical shape nonaqueous electrolytic solution secondary battery, a laminate case type nonaqueous electrolytic solution secondary battery, or the like.

The nonaqueous electrolytic solution secondary battery 100 can be used for various purposes, and can have both the suppressed resistance increasing rate and the suppressed reduction of the capacity maintenance rate after the storage, or the like, and thus it can be in particular suitably used as a power source for a motor (a power supply for driving) mounted on a moving body, for example, a vehicle, such as passenger car and truck. Although a type of the vehicle is not particularly restricted, it might be, for example, a plug-in hybrid vehicle (PHEV; Plug-in Hybrid Electric Vehicle), a hybrid vehicle (HEV; Hybrid Electric Vehicle), an electric vehicle (BEV; Battery Electric Vehicle), or the like. The nonaqueous electrolytic solution secondary battery 100 could be used even in a form of a battery pack configured by connecting plural ones in series and/or in parallel.

Below, a practical example related to the present disclosure would be explained, but it is not intended to restrict the present disclosure to the practical example described below.

### Practical Example 1

As the negative electrode active material, the graphite in which the amorphous carbon was coated was prepared. In particular, at first, a graphite being commercially available and a coal tar pitch being as a raw material of the amorphous carbon were prepared. Then, the CVD was used, and thus the coal tar pitch was made to stick on the surface of the graphite. Then, by baking the graphite, on which the coal tar pitch stuck, at 800 to 1500° C. under a non-oxidizing atmosphere, the graphite in which the amorphous carbon was coated was manufactured. This was treated as the negative electrode active material of Practical example 1.

Then, the styrene butadiene rubber (SBR) as the binding agent and the carboxymethyl cellulose (CMC) as the thickening agent were prepared. The negative electrode active material of Practical example 1 manufactured as described above, the SBR, and the CMC were mixed with ion exchange water at a mass ratio of negative electrode active material: SBR: CMC=98:1:1, so as to prepare a negative electrode slurry. This slurry was applied to coat the both surfaces of the long copper foil in a strip-like shape and dried, and then the resultant was pressed so as to manufacture the negative electrode sheet.

Then, LiNi_{1/3}Co_{1/3}Mn_{1/3}O₂ (NCM) as the positive electrode active material, the acetylene black (AB) as the electrically conducting material, and the polyvinylidene fluoride (PVdF) as the binder were prepared. These materials were mixed with N-methyl pyrrolidone (NMP) at a mass ratio of NCM: AB: PVdF=92:5:3, so as to prepare the slurry for forming the positive electrode active material layer. This slurry was made to coat the both surfaces of the long aluminum foil in a strip-like shape and dried, and then the resultant was pressed so as to manufacture the positive electrode sheet.

As the separator, a porous polyolefin sheet having a three layers structure of PP/PE/PP and being provided with HRL was prepared. The positive electrode sheet and the negative electrode sheet, manufactured above, and 2 separator sheets prepared above were laminated and then wound, so as to manufacture the wound electrode body.

Then, the nonaqueous electrolytic solution was prepared. As the carbonate type solvent, ethylene carbonate and dimethyl carbonate were prepared. A mix solvent containing ethylene carbonate (EC), dimethyl carbonate (DMC), and methyl acetate (MA) at a volume ratio of 30:70-X: X was prepared. Incidentally, a value of X (volume ratio; it means volume %, too) was made to be a value shown in Table 1. Into this mix solvent, the lithium bis(fluorosulfonyl)imide (LiFSI) was dissolved to be at 0.5 mass % concentration, and the LiPF₆ as the electrolyte salt was dissolved to be at 1.0 mol/L concentration. By doing this, the nonaqueous electrolytic solution was prepared.

Terminals were attached to the electrode body manufactured above, the resultant was accommodated in the battery case together with the nonaqueous electrolytic solution prepared above, and then the resultant was airtightly sealed. After that, the activation treatment was performed, and then the lithium ion secondary battery for evaluation of Practical example 1 was obtained.

### Practical Examples 2 and 3

In Practical examples 2 and 3, the content amount (vol %) of methyl acetate (MA) was changed as shown in Table 1. Except for this matter, similarly to Practical example 1, the lithium ion secondary batteries for evaluation of Practical examples 2 and 3 were manufactured.

### Practical Example 4

In Practical example 4, the baking temperature was changed so as to make the crystallinity of the outermost surface of the negative electrode active material de different. In addition, the content amount (vol %) of the methyl acetate (MA) was changed as shown in Table 1. Except for these matters, similarly to Practical example 1, the lithium ion secondary battery for evaluation of Practical example 4 was manufactured.

### Comparative Example 1

In Comparative example 1, the content amount (vol %) of methyl acetate (MA) was changed to be as shown in Table 1. Except for these matters, similarly to Practical example 1, the lithium ion secondary battery for evaluation of Comparative example 1 was manufactured.

### Comparative Examples 2 to 4

In Comparative examples 2 to 4, the baking temperature was changed so as to make the crystallinity of the outermost surface of the negative electrode active material be different. In addition, the content amount (vol %) of the methyl acetate (MA) was changed to be as shown in Table 1. Except for these matters, similarly to Practical example 1, the lithium ion secondary batteries for evaluation of Comparative examples 2 to 4 were manufactured.

### Comparative Examples 5 to 7

In Comparative examples 5 and 7, the baking temperature was changed so as to make the crystallinity of the outermost surface of the negative electrode active material be different. Additionally, in Comparative examples 5 to 7, methyl propionate (MP) instead of methyl acetate was used. Then, the content amount (vol %) of this methyl propionate was changed to be as shown in Table 1. In other words, regarding Comparative examples 5 to 7, a mix solvent containing ethylene carbonate (EC), dimethyl carbonate (DMC), and methyl propionate (MP) at a volume ratio of 30:70-X: X was prepared. Except for these matters, similarly to Practical example 1, the lithium ion secondary batteries for evaluation of Comparative examples 5 to 7 were manufactured.

### <Measurement of Initial Capacity>

Each of the above described lithium ion secondary batteries for evaluation having been activated was subjected to a constant current electric charge by 0.2 C current value to 4.10 V, and then subjected to a constant-current/constant-voltage electric charge, in which the constant voltage electric charge was performed until making the current value reach 1/50 C, and thus a full electric charge state was implemented. Then, a constant current electric discharge was performed by 0.2 C current value to 3.00 V, and then, a constant-current/constant-voltage electric discharge was performed in which the constant voltage electric discharge was performed until making the current value reach 1/50 C. The electric discharge capacity at that time was measured and then this value was treated as an initial capacity of each lithium ion secondary battery for evaluation.

### <Evaluation of Resistance Increasing Rate>

The above described initial capacity was treated as SOC 100%, and each lithium ion secondary battery for evaluation was electrically charged in a thermostatic chamber at −10° C. by 1 C current value until making the SOC reach 50%. Then, in the thermostatic chamber at −10° C., the electric charge was performed by 1 C, 3 C, 5 C, and 10 C current values for 10 seconds, the battery voltage after the electric charge by each current value was measured. Each of current values and each of battery voltages were plotted so as to obtain a I-V characteristic at the electrically charging time, and then, based on an inclination of the obtained straight line, a IV resistance (Ω) at the electrically discharging time was obtained. This value was treated as an initial resistance value of each lithium ion secondary battery for evaluation.

Then, the above described initial capacity was treated as SOC 100%, then each lithium ion secondary battery for evaluation was charged in the thermostatic chamber at −10° C. by 15 C current value until reaching the SOC 50%. This each lithium ion secondary battery for evaluation was kept inside the thermostatic chamber being set to be at 60° C., and was stored for 150 days. After that, in the thermostatic chamber being set to be −10° C., the electric charges were performed for 10 seconds by 1 C, 3 C, 5 C and 10 C current values, and then the battery voltage after the electric charge by each current value was measured. Each of current values and each of battery voltages were plotted so as to obtain the I-V characteristic at the electrically charging time, and then, based on the inclination of the obtained straight line, the IV resistance (52) at the electrically discharging time was obtained. This value was treated as a resistance value after the storage of each lithium ion secondary battery for evaluation. With a formula: (IV resistance value after storage/initial IV resistance value)×100; the resistance increasing rate (%) was obtained. The resistance increasing rate of the lithium ion secondary battery for evaluation of Comparative example 6 was treated as 100, and then the ratios of the resistance increasing rates of the other lithium ion secondary batteries for evaluation with respect to the lithium ion secondary battery for evaluation of Comparative example 6 were obtained. Results are shown in Table 1.

### <Evaluation of Capacity Maintenance Rate>

Each of the above described lithium ion secondary batteries for evaluation after the storage was subjected to the constant current electric charge by 0.2 C current value to 4.10 V, and then subjected to the constant-current/constant-voltage electric charge, in which the constant voltage electric charge was performed until making the current value reach 1/50 C, and thus the full electric charge state was implemented. The constant current electric discharge was performed by 0.2 C current value to 3.00 V, and then, the constant-current/constant-voltage electric discharge was performed in which the constant voltage electric discharge was performed until making the current value reach 1/50 C. The electric discharge capacity at that time was measured and then this value was treated as an electric discharge capacity after the storage. The initial capacity and the electric discharge capacity measured as described above were used, and with a formula: (electric discharge capacity after storage/initial capacity)×100; the capacity maintenance rate (%) was obtained. The capacity maintenance rate of the lithium ion secondary battery for evaluation of the comparative example 6 was treated as 100, and then the ratios of the initial resistances of the other lithium ion secondary batteries for evaluation with respect to the lithium ion secondary battery for evaluation of Comparative example 6 were obtained. Results are shown in Table 1.

### <Calculation of D/G Ratio>

The lithium ion secondary battery for evaluation after the storage test of each example was disassembled and then the analysis of the negative electrode active material was performed. The negative electrode active material of each example was analyzed by a Raman spectroscopic analysis apparatus (a microscopic Raman spectrometer made by Renishaw company, in Via Reflex 785S, excitation wavelength 532 nm, Ar laser), so as to obtain a Raman spectrum. The peak strength G at 1580 cm⁻¹ and the peak strength D at 1360 cm⁻¹ of the Raman spectrum were measured, and then the ratio (D/G ratio) of the peak strength D and the peak strength G was obtained. The calculated value was shown in Table 1.

### <XPS Measurement on Negative Electrode Active Material Layer>

The lithium ion secondary battery for evaluation of each example after the storage test was disassembled, and then, with a XPS apparatus, the analysis on the negative electrode active material layer was performed. In particular, on these negative electrode active material layers, with the XPS apparatus (“PHI 5000 VersaProbe 2” made by ULVAC-PHI company), measurement was performed under a condition of X-ray source: AlKα ray (monochromatic light), irradiation range: φ100 μm, and current/voltage: 25 kW 15 kV. Based on the obtained XPS spectrum, curve fitting was performed on the peak Ps of the SOx which appeared at a position whose binding energy is near 169 eV, so as to obtain the peak area size. Incidentally, a shift correction of the peak was measured, after a correction was performed while the peak of C1s was treated as 284.80 eV. By doing this, the SOx concentration (atomic %) was calculated. Results are shown in Table 1.

TABLE 1

| | Solvent composition | | | | Ratio of | Ratio of |
|---|---|---|---|---|---|---|
| | | Volume | | | resistance | capacity |
| | | ratio X | D/G | Sox concentration | increasing | maintenance |
| | Type | (vol %) | ratio | (atomic %) | rate | rate |
| Comparative example 1 | MA | 3 | 0.35 | 0.1 | 99 | 100 |
| Practical example 1 | MA | 10 | 0.35 | 0.3 | 97 | 102 |
| Practical example 2 | MA | 30 | 0.35 | 0.6 | 93 | 106 |
| Practical example 3 | MA | 70 | 0.35 | 0.7 | 91 | 106 |
| Comparative example 2 | MA | 10 | 0.25 | 0.1 | 98 | 100 |
| Comparative example 3 | MA | 70 | 0.25 | 0.2 | 98 | 101 |
| Comparative example 4 | MA | 10 | 0.45 | 0.1 | 101 | 99 |
| Practical example 4 | MA | 70 | 0.45 | 0.3 | 99 | 101 |
| Comparative example 5 | MP | 10 | 0.25 | Lower than detection | 99 | 100 |
| | | | | limit value | | |
| Comparative example 6 | MP | 10 | 0.35 | Lower than detection | 100 | 100 |
| | | | | limit value | | |
| Comparative example 7 | MP | 10 | 0.45 | Lower than detection | 101 | 98 |
| | | | | limit value | | |

As shown in Table 1, regarding Practical example 1 to 4 in which the D/G ratio of the negative electrode active material is equal to or more than 0.3 and not more than 0.5, in which the nonaqueous electrolytic solution contains the sulfur type electrolyte salt, the carbonate type solvent, and methyl acetate, and in which the SOx concentration based on the XPS is equal to or more than 0.3 atomic %, it can be understood that the resistance increasing rate is lower and the capacity maintenance rate is higher. As shown in this result, according to the herein disclosed nonaqueous electrolytic solution secondary battery, it is possible to implement the nonaqueous electrolytic solution secondary battery in which the increase of the resistance value even after the storage can be suitably suppressed and in which the high capacity maintenance rate can be secured.

Above, the herein disclosed technique has been explained in detail, but these are merely illustrations, and thus these are not intended to restrict the scope of claims. The technique recited in claims contains matters in which the above-illustrated specific examples are variously deformed or changed.

While described above, as a particular aspect of the herein disclosed technique, it is possible to use a recitation of each item described below.

Item 1: A nonaqueous electrolytic solution secondary battery, comprising: a positive electrode; a negative electrode; and a nonaqueous electrolytic solution, wherein the negative electrode comprises a negative electrode active material layer containing a negative electrode active material, the negative electrode active material comprises a carbon material and an amorphous carbon coat layer covering the carbon material, in the negative electrode active material, a strength ratio (D/G) of a peak strength G at 1580 cm⁻¹ and a peak strength D at 1360 cm⁻¹ under a Raman spectrum analysis measured by a Raman spectroscopy is equal to or more than 0.3 and not more than 0.5, the nonaqueous electrolytic solution contains at least a sulfur type electrolyte salt and a nonaqueous solvent, the nonaqueous solvent contains a carbonate type solvent and methyl acetate, and in the negative electrode active material layer, a SOx concentration calculated on a basis of a XPS spectrum measured by a X-ray photoelectron spectroscopy is equal to or more than 0.3 atomic %.

Item 2: The nonaqueous electrolytic solution secondary battery recited in item 1, wherein the nonaqueous solvent of the nonaqueous electrolytic solution has a content amount of the methyl acetate being equal to or more than 10 vol % and not more than 70 vol % when a whole of the nonaqueous solvent is treated as 100 vol %.

Item 3: The nonaqueous electrolytic solution secondary battery recited in item 1, wherein the carbonate type solvent contains at least ethylene carbonate.

Item 4: The nonaqueous electrolytic solution secondary battery recited in any one of item 1 to item 3, wherein the sulfur type electrolyte salt contains lithium bis(fluorosulfonyl)imide.

What is claimed is:

1. A nonaqueous electrolytic solution secondary battery, comprising:
a positive electrode;
a negative electrode; and
a nonaqueous electrolytic solution, wherein
the negative electrode comprises a negative electrode active material layer containing a negative electrode active material,
the negative electrode active material comprises a carbon material and an amorphous carbon coat layer covering the carbon material,
in the negative electrode active material, a strength ratio (D/G) of a peak strength G at 1580 cm⁻¹ and a peak strength D at 1360 cm⁻¹ under a Raman spectrum analysis measured by a Raman spectroscopy is equal to or more than 0.3 and not more than 0.5,
the nonaqueous electrolytic solution contains at least a sulfur type electrolyte salt and a nonaqueous solvent,
the nonaqueous solvent contains a carbonate type solvent and methyl acetate, and
in the negative electrode active material layer, a SOx concentration calculated on a basis of a XPS spectrum measured by a X-ray photoelectron spectroscopy is equal to or more than 0.3 atomic %.

2. The nonaqueous electrolytic solution secondary battery according to claim 1, wherein
the nonaqueous solvent of the nonaqueous electrolytic solution has a content amount of the methyl acetate being equal to or more than 10 vol % and not more than 70 vol % when a whole of the nonaqueous solvent is treated as 100 vol %.

3. The nonaqueous electrolytic solution secondary battery according to claim 1, wherein
the carbonate type solvent contains at least ethylene carbonate.

4. The nonaqueous electrolytic solution secondary battery according to claim 1, wherein
the sulfur type electrolyte salt contains lithium bis(fluorosulfonyl)imide.
